(19) United States
(12) Patent Application Publication
(10) Pub. No.: US 2015/0072539 A1
(43) Pub. Date: Mar. 12, 2015

(54) USB INTERFACE AND TERMINAL

(71) Applicant: Weibo Xie, Shenzhen (CN)

(72) Inventor: Weibo Xie, Shenzhen (CN)

(21) Appl. No.: 14/395,788

(22) PCT Filed: Jul. 16, 2012
(86) PCT No.: PCT/CN2012/078722

§ 371 Date: Oct. 20, 2014

(30) Foreign Application Priority Data
Apr. 19, 2012 (CN) 201210116992.5

(51) Int. Cl. H01R 35/02; H01R 13/15

(52) U.S. Cl. CPC H01R 35/02; H01R 13/15
USPC 439/13

(57) ABSTRACT

A USB interface and a terminal comprising the USB interface. The USB interface comprises a USB jack (201), a first metal piece (203) and a second metal piece (207). The USB jack is fixedly connected to the first metal piece. The first metal piece is connected to the second metal piece through a first rotating shaft (205). The second metal piece is electrically connected to a ground plane of a main board (30) of a PCB of the terminal. When the USB jack is rotated, the USB jack drives the first metal piece to rotate by a first predetermined angle through the first rotating shaft. The USB jack may implement a good electrical connection between a computer main board and the main board of the PCB of the terminal, and equivalently extend the length of the main board of the PCB of the terminal.

### TECHNICAL FIELD

The disclosure relates to the field of electronics and communications, and in particular to a universal serial bus (USB) interface and terminal.

### BACKGROUND

With the development of the modem communication technology, the wireless network is widely applied, the mobile communication terminal develops greatly, and a variety of mobile communication terminals are appearing, are different in shape, and became smaller in size. In a design, a ground plane of a printed circuit board (PCB) is used as a resonant unit of an antenna, with a length no less than ¼ of an operating wavelength λ. Therefore, when the length of the PCB ground plane is less than ¼ of the operating wavelength λ, the performance of the antenna on the communication terminal becomes poor, in general, the neck of the length of the PCB ground plane depends on the lowest operating frequency of the USB communication terminal, the lower the frequency, the longer the required length of the PCB ground plane.

A conventional communication terminal is a wireless data card generally, and the interface of the data card is generally a USB interface. Some data cards use a direct-insertion USB interface, and some use a rotary USB interface. In a case where a direct-insertion USB interface is used, when a data card is inserted into a USB socket of the main board on the computer, a ground of the PCB main board of the data card is in good communication with a ground of the PCB main board of the computer via the USB interface, which can be viewed as a same ground plane the level of which is equal to the level of the ground. It is equivalent to increasing the PCB size of the terminal, thereby effectively improving antenna parameters of the terminal at low frequency.

If a rotary USB interface is used, a ground wire in the USB interface is connected with the main board on the computer. The above-mentioned solution is employed in all the current similar products; however, since the ground wire has small cross sectional area and cannot implement good electrical communication between the ground planes of the terminal and the main board of the computer. When the terminal operates at a low frequency range, the antenna performance will deteriorate due to the limitation of the length of PCB (less than ¼ of the operating wavelength λ), and thus cannot meet design requirements. FIG. 1 shows a schematic diagram of a connection type between a conventional rotary USB jack and a PCB according to the traditional art. As shown in FIG. 1, a USB interface 101 comprise +5V, D+, D− and GND data wires, wherein the +5V wire supplies power for the terminal, the D+ and D− wires perform data communication, and the GND wire provides a path for current returning. Here, the communication with the ground plane is implemented only via the GND wire; however, by the limitation of the length of the terminal PCB 103, the PCB size alone would not meet the length required by the antenna of low frequency resonance. Therefore, the antenna performance of the terminal using such interface deteriorates slightly at low frequency than at high frequency.

At present, some manufacturers modify the ground connection of the rotary USB interface, and use a metal plate other than the ground to connect with the USB shell, such that when a user inserts the terminal on a laptop, the PCB ground plane communicates with the main board of the laptop via the USB shell. It is equivalent to extending the ground length of the terminal, thereby improving the performance of the antenna at a low frequency.

However, in this way, the metal plate is electrically communicated with the PCB by means of contacting, such that when the contact between the metal plate and the PCB is oxidized, the antenna performance will deteriorate. The both cannot be in good contact with each other sufficiently, and it is hard to ensure the product conformity in mass production.

There is no effective solution proposed for the above-mentioned problems in the related technologies.

### SUMMARY

Aiming at the technical problems, such as the poor performance of antenna in the implementations of a USB interface of a terminal, in the traditional art, the disclosure provides a USB interface and terminal to at least solve the above-mentioned problems.

A USB interface is provided according to an embodiment of the disclosure, comprising: a USB jack fixedly connected to a first metal piece; the first metal piece connected with a second metal piece via a first rotating shaft, wherein when rotating the USB jack, the USB jack drives the first metal piece to rotate by a first predetermined angle via the first rotating shaft; and the second metal piece electrically connected with a ground plane of a terminal printed circuit board (PCB) main board.

The first rotating shaft is a metal piece.

The first predetermined angle is 270°.

The ground plane is a copper pour area after being processed of brightening copper.

The USB interface also comprises a third metal piece and a second rotating shaft, the third metal piece being connected between the first metal piece and the second metal piece, wherein the third metal piece is connected with the first metal piece via the second rotating shaft, and when rotating the USB jack, the USB jack drives the third metal piece to rotate by a second predetermined angle via the second rotating shaft.

The second rotating assembly is a metal piece.

The second predetermined angle is 90°.

A terminal is provided according to another embodiment of the disclosure, comprising the above-mentioned USB interface.

The first rotating shaft of the USB interface is provided on the PCB main board of the terminal.

In the disclosure, the USB jack is fixedly connected to the first metal piece, and the first metal piece is connected with a second metal piece via a first rotating shaft, wherein when rotating the USB jack, the USB jack drives the first metal piece to rotate by a first predetermined angle via the first rotating shaft. Through the above-mentioned solution, the problem in the traditional art that the antenna performance in the implementations of the USB interface of the terminal is poor is solved, so that the electrical connection between the terminal and the computer is improved and the antenna performance of the terminal is improved.

### DESCRIPTION OF THE ACCOMPANYING DRAWINGS

Drawings, provided for further understanding of the disclosure and forming a part of the specification, are used to explain the disclosure together with embodiments of the disclosure rather than to limit the disclosure, wherein:

FIG. 1 shows a schematic diagram of a connection type between a conventional rotary USB jack and a PCB according to the traditional art;

FIG. 2 shows a structural schematic diagram of a USB interface according to an embodiment of the disclosure; and

FIG. 3 shows a structural schematic diagram of a USB interface according to a preferred embodiment of the disclosure.

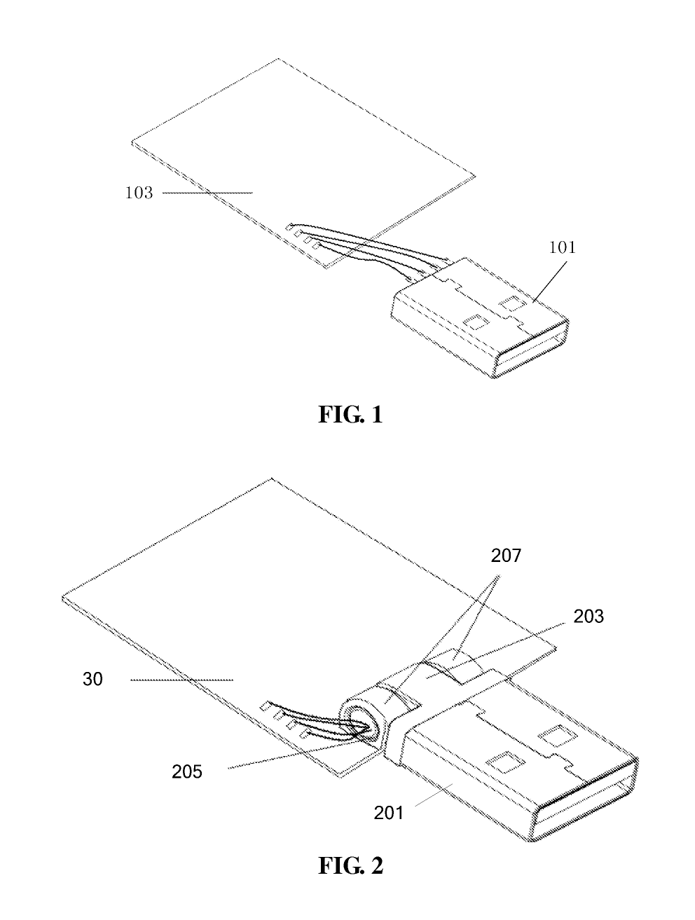

### DETAILED DESCRIPTION OF THE EMBODIMENTS

The disclosure is described below with reference to the accompanying drawings and embodiments in detail. It should be noted that, the embodiments of the disclosure and the features of the embodiments can be combined with each other if there is no conflict.

FIG. 2 shows a structural schematic diagram of a USB interface according to an embodiment of the disclosure. As shown in FIG. 2, the USB interface comprise: a USB jack 201 fixedly connected with a first metal piece 203; the first metal piece 203 connected with a second metal piece 207 via a first rotating shaft 205, wherein when rotating the USB jack 201, the USB jack 201 drives the first metal piece 203 to rotate by a first predetermined angle via the first rotating shaft 205; and the second metal piece 207 configured to electrically connect with a ground plane of a PCB main board 30 on a terminal.

In the above-mentioned structural feature, through the first rotating shaft, the good electrical communication between the main board on the computer and the PCB on the terminal is realized. It is equivalent to extending the length of the PCB on the terminal, so as to effectively solve the problem of poor antenna performance of the terminal due to the insufficient length of PCB, thereby effectively improving the antenna performance of terminal communication products.

For the purpose of improving the electrical connection performance, the above-mentioned first rotating shaft 205 may be a metal piece.

The above-mentioned first rotating shaft 205 may be configured to rotate by a specified angle (the first predetermined angle), e.g., 270° or 90°, according to the actual conditions. It should be noted that the rotation direction of the above-mentioned rotating shaft would be up-and-down and/or left-and-right.

For the purpose of improving the electrical contact effect between the second metal piece and the PCB ground plane of the main board on the terminal, the above-mentioned PCB ground plane may be a copper pour area after being processed of brightening copper according to a preferred embodiment of the disclosure.

The USB interface in the above-mentioned embodiment may be implemented by the following treatment steps:

step I: the USB jack is fixed on a metal structural component (i.e., the first metal piece), the metal structural component being connected with another metal structural component (i.e., the second metal piece) via a metal rotating shaft (i.e., the first rotating shaft), with a rotating range of 270°; and

step II: a good electrical connection between the metal structural components and the copper ground of PCB is set, wherein a connection type may be pressure welding, welding, fastening by mechanical methods, etc.

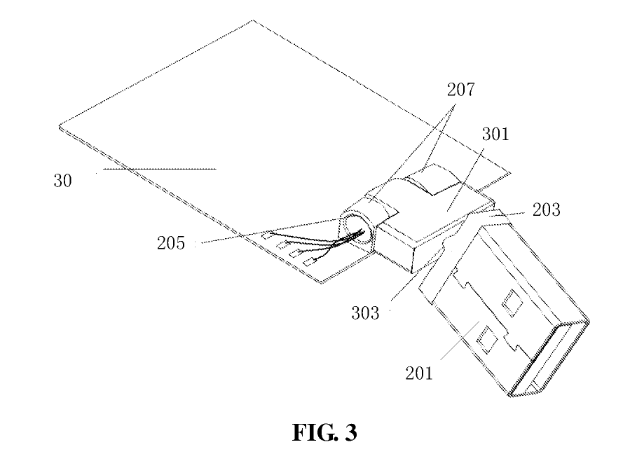

When the above-mentioned first rotating shaft is configured to rotate up-and-down/left-and-right, the following process may be used to implement left-and-right/up-and-down rotation of the USB interface, i.e., the multi-directional rotation of the USB interface: as shown in FIG. 3, the above-mentioned USB interface may comprise a third metal piece 301 and a second rotating shaft 303, the above-mentioned third metal piece 301 being connected between the first metal piece 203 and the second metal piece 207, wherein the third metal piece 301 is connected with the first metal piece 203 via the second rotating shaft 303; and when rotating the USB jack 201, the USB jack 201 drives the third metal piece 301 to rotate by a second predetermined angle via the second rotating shaft 303.

It should be noted that the above-mentioned second rotating shaft would rotate in the up, down, left or right direction, or rotate in a 360° multi-directional manner.

Similar to the first rotating shaft 205, for the purpose of improving the electrical connection performance, the above-mentioned second rotating assembly may be a metal piece.

The above-mentioned second predetermined angle may be a specified angle, e.g., 90° according to the actual conditions.

In the above-mentioned embodiment, when the USB interface has the second rotating shaft, the following treatment steps may be implemented:

step I: the USB jack is fixed on a metal structural component 203 (i.e., the first metal piece), the metal structural component 203 being connected with another metal structural component 301 (i.e., the third metal piece) via a metal rotating shaft 303 (i.e., the second rotating shaft), with a rotating range of +/−90°;

step II: a metal structural component 301 is connected (i.e., the third metal piece) with another metal structural component 207 (i.e., the second metal piece) via a metal rotating shaft 205 (i.e., the first rotating shaft), with a rotating range of +90°/−180°; and

step III: a dimensional 360° rotation may be implemented by fitting of the above two metal rotating shafts. The metal structural component 207 is in good electrical connection with the copper ground of PCB, with a connection type of pressure welding, welding, fastening by mechanical methods, etc.

Since the USB interfaces in the above-mentioned embodiments are generally applied to terminals, this embodiment also provides a terminal comprising the above-mentioned USB interface. The above-mentioned terminal may be a mobile communication terminal or a wireless data card. The first rotating shaft of the USB interface is arranged on the PCB main board of the terminal. The connection type between the first rotating shaft and the PCB ground plane may be pressure welding, welding, screw fastening, etc.

It should be noted that the interior of each of the above-mentioned metal structural components may be hollow or be filled with filler.

When a wireless data card or a terminal having the above-mentioned USB interface is connected with a computer, good electrical connection between the computer main board and the terminal PCB may be implemented by means of such metal rotating shafts, equivalent to extending the length of the terminal PCB, so as to effectively solve the problem of poor antenna performance due to the insufficient length of PCB in some terminal products, especially to improve to the maximum the performance of the antenna at low frequency of the terminal products, as well as to improve the production conformity and operational reliability of products, improve the quality of terminal communication products, and also reduce the operating temperature of communication terminals through the computer main board.

The descriptions above are only the preferable embodiment of the disclosure, which are not used to restrict the disclosure, for those skilled in the art, the disclosure may have various changes and variations. Any amendments, equivalent substitutions, improvements, etc. within the principle of the disclosure are all included in the scope of the protection of the disclosure.

1. A USB interface, comprising:
a USB jack, fixedly connected to a first metal piece;
the first metal piece, connected with a second metal piece via a first rotating shaft, wherein when rotating the USB jack, the USB jack drives the first metal piece to rotate by a first predetermined angle via the first rotating shaft; and
the second metal piece, electrically connected with a ground plane of a printed circuit board (PCB) main board.

2. The USB interface according to claim 1, wherein the first rotating shaft is a metal piece.

3. The USB interface according to claim 1, wherein the first predetermined angle is 270°.

4. The USB interface according to claim 1, wherein the ground plane is a copper pour area after being processed of brightening copper.

5. The USB interface according to claim 1, further comprising a third metal piece and a second rotating shaft, wherein
the third metal piece is connected between the first metal piece and the second metal piece, wherein the third metal piece is connected with the first metal piece via the second rotating shaft; and when rotating the USB jack, the USB jack drives the third metal piece to rotate by a second predetermined angle via the second rotating shaft.

6. The USB interface according to claim 5, wherein the second rotating shaft is a metal piece.

7. The USB interface according to claim 5, wherein the second predetermined angle is 90°.

8. A terminal, comprising the USB interface according to claim 1.

9. The terminal according to claim 8, wherein the first rotating shaft of the USB interface is provided on the PCB main board.

10. A terminal, comprising the USB interface according to claim 2.

11. A terminal, comprising the USB interface according to claim 3.

12. A terminal, comprising the USB interface according to claim 4.

13. A terminal, comprising the USB interface according to claim 5.

14. A terminal, comprising the USB interface according to claim 6.

15. A terminal, comprising the USB interface according to claim 7.
